(19) United States
(12) Patent Application Publication
(10) Pub. No.: US 2018/0323002 A1
(43) Pub. Date: Nov. 8, 2018

(54) SMD INDUCTOR WITH HIGH PEAK CURRENT CAPACITY AND LOW LOSSES, AND METHOD FOR THE PRODUCTION THEREOF

(71) Applicant: EPCOS AG, München (DE)

(72) Inventors: Dirk Beckmann, Heidenheim (DE); Anneliese Drespling, Heidenheim (DE); Felipe Jerez, Elchingen (DE)

(73) Assignee: EPCOS AG, Munchen (DE)

(21) Appl. No.: 15/771,576

(22) PCT Filed: Nov. 10, 2016
(86) PCT No.: PCT/EP2016/077318

§ 371 Date: Apr. 27, 2018

(30) Foreign Application Priority Data
Nov. 20, 2015 (DE) 10 2015 120 162.3

(51) Int. Cl. H01F 27/29; H01F 17/04; H01F 27/28

(52) U.S. Cl. CPC H01F 27/292; H01F 2003/106; H01F 27/2823; H01F 17/045

(57) ABSTRACT

An SMD inductor as a component and a method for producing an SMD inductor. The inductor simultaneously has low losses and a high peak current-carrying capacity and also a high mechanical stability. To that end, it includes an inner core piece, an outer core piece and a coil having a wire. The inner core piece includes an alloy. The outer core piece includes ferrite. The wire is wound around the inner core piece, and the inner core piece with the wire is arranged in the outer core piece.

### CROSS-REFERENCE TO RELATED APPLICATIONS

This application is a U.S. National Stage of International Application No. PCT/EP2016/077318, filed Nov. 10, 2016, which claims the benefit of Germany Patent Application No. 102015120162.3, filed Nov. 20, 2015, both of which are incorporated herein by reference in their entireties.

SMD inductor with high peak current capacity and low losses, and method for the production thereof.

The invention relates to SMD inductors, that is to say electrical components suitable for surface mounting, having a desired inductance value L, and to methods for producing such components.

SMD inductors (SMD=surface mounted device) can readily be combined with other circuit components in circuits since they can easily be applied on printed circuit boards and be interconnected with electrical conductors on the printed circuit board. In comparison with inductors realized as structured conductor track sections in or on printed circuit boards, SMD inductors have particularly high quality factors Q.

SMD inductors are intended to have low losses and high peak current-carrying capacities. Previous inductors composed of iron alloys are produced in such a way that a winding is enveloped with material and this is then pressed. The winding wire is subjected to prior damage as a result of this process.

SMD inductors are intended to have a high mechanical stability anyway. Customary SMD inductors require a high material thickness in order to be able to withstand specific requirements sufficiently stably, e.g. drop tests, in which the component is dropped for test purposes.

Customary SMD inductors furthermore have the problem that they have either low losses or a high peak current-carrying capacity.

It is therefore an object of the present invention to specify SMD inductors which have both a high peak current-carrying capacity and low losses. Furthermore, the inductors are intended to be able to be produced cost-effectively and to be mechanically stable in order not to jeopardize the reliability of the entire circuit having the SMD inductor.

Furthermore, a method for producing such inductors is intended to be specified.

These objects are achieved by means of the SMD inductor and respectively the method for producing an SMD inductor according to the independent claims. Dependent claims specify advantageous configurations.

The SMD inductor comprises an inner core piece, an outer core piece and a coil having a wire. The inner core piece comprises an alloy. The outer core piece comprises ferrite. The wire is wound around the inner core piece and together with the inner core piece forms the coil. The inner core piece with the wire is arranged in the outer core piece.

In addition, the SMD inductor can comprise external terminals via which the coil is interconnectable with an external circuit environment.

The inner core piece can be a DR core or have a construction similar to that of a DR core (DR=DRum core). In this case, the inner core piece can comprise an iron alloy or consist of an iron alloy.

The outer core piece can be an RI core or have a construction similar to that of an RI core (RI=RIng core).

It is possible for the inner core piece to comprise a central section having a round, oval or polygonal cross section. The wire is wound around the central section of the inner core piece.

It is furthermore possible for the alloy of the inner core piece to comprise iron.

It is furthermore possible for the alloy of the inner core piece to comprise a sintered material.

It is furthermore possible for sintered material to be free of a binder.

In this case, the sintered material can comprise grains having an average grain size of a few micrometers.

In particular, the grain size of the iron alloy of the present inductor can be smaller than the grain size of customary SMD inductors.

In this case, the grains of the iron alloy can be isolated from one another, such that an iron alloy having reduced losses is obtained and hence an SMD inductor having an improved quality factor Q is obtained.

The use of smaller and individually isolated grains enables an increased density of the material, as a result of which it is possible to achieve an increased magnetic saturation and reduced electrical losses during the operation of the inductor.

It is possible for the wire of the coil to have a number of turns Z where 1.5≤Z≤100. The inductance L of the SMD inductor can be set in a simple manner through the choice of the material of the inner core piece, of the outer core piece and the number of turns of the coil.

It is possible for the material of the inner core piece to comprise silicon and iron. An inner core piece comprising silicon and iron is preferred here, wherein the iron content is preferably significantly greater than the silicon content of the inner core piece. Core pieces without silicon are also possible.

The SMD inductor can thus have inductance values L of between 0.3 and 100 μH.

Besides the abovementioned wire of the coil, the inductor can also comprise one or a plurality of additional wires. In this case, the one additional wire or the plurality of additional wires can be interconnected in series or in parallel with the abovementioned wire. In one specific embodiment, all wires of the inductor are interconnected in parallel. Combinations of series and parallel interconnections are also possible.

The total number of wires can be 100 or more.

All the individual wires can be combined e.g. in a parallel connection to form a multiple-stranded wire. The multiple-stranded wire comprising the individual wires can be wound around the inner core piece. In this case, the wire, the wire and the additional wires and/or the multiple-stranded wire can be wound in particular around the central section of the inner core piece if the inner core piece comprises a central section.

It is possible for the outer core piece to comprise an outer wall having a cutout. The cutout has a first area and a second area, which is not parallel to the first area. The transition from the first area to the second area for the purpose of avoiding stress cracks is shaped asymmetrically in relation to an angle bisector with respect to both areas.

The outer core piece accommodates the inner core piece with the coil. In order that the coil is interconnectable with an external circuit environment, electrical contacts have to be led to the outer surface of the SMD inductor. This contact can be led through the cutout in the outer wall of the outer core piece. A cutout in an outer wall of the outer core piece is problematic at customary SMD inductors because mechanically induced stress cracks can occur at edges of the cutout if the SMD inductor is subjected to external forces, e.g. the acceleration or the deceleration in a drop test.

Two non-parallel areas intersect at a straight line. With respect to these two areas there is a further area that intersects the first two areas along said straight line and forms the same angle with each of the two first areas. In this case, the straight line of intersection constitutes the edge of a cutout that is particularly jeopardized by mechanical influencing.

The abovementioned transition can be provided instead of a sharp edge and be configured in particular asymmetrically in relation to the angle bisector in order to prevent such stress cracks.

In this case, the transition can comprise transition dimensions a and b that are different from one another (a≠b).

In particular, the edge of the cutout can be blunted as a result of two mutually perpendicular surfaces meeting one another as a result of the formation of the transition.

The peak current-carrying capacity W is the product of the inductance L and the square of the current: W=L*I².

A high peak current-carrying capacity is defined by an energy content L*I² where L=0.9*L₀. In this case, L₀ is the inductance without current, and I is the current at which L=0.9*L₀.

In the case of a component having a basic area of 12 mm×12 mm, the peak current-carrying capacity can be greater than or equal to 1.2 mWs.

In the case of a component having a basic area of 10 mm×10 mm, the peak current-carrying capacity can be greater than or equal to 0.45 mWs.

In the case of a component having a basic area of 7 mm×7 mm, the peak current-carrying capacity can be greater than or equal to 0.36 mWs.

In the case of a component having a basic area of 6 mm×6 mm, the peak current-carrying capacity can be greater than or equal to 0.25 mWs.

In this case, the corresponding component can have a rectangular basic area.

It is possible for the losses, e.g. at a frequency of 300 kHz, at 30 mT and at 20° C., to be less than or equal to 600 kW/m³ in the core material.

A method for producing an SMD inductor comprises the following steps:
providing an inner core piece composed of an alloy, an outer core piece comprised of ferrite, and a wire,
winding the wire onto the inner core piece to form a coil,
arranging the inner core piece with the coil in the outer core piece,
interconnecting the coil with external terminals.

In contrast to the production of customary SMD inductors, in which the wire of the winding is enveloped by a material and embedded therein after compression, the risk of damage to the wire during winding onto the inner core piece is virtually eliminated. By virtue of the fact that devices for winding coils for similar components can be used with minor modifications for the production of the present inductors, this results in a method that can be realized simply and cost-effectively for the production of SMD inductors with improved fail-safety of the inductors.

It is possible for the wire of the coil to be connected by means of welding or soldering methods to the external terminals with which the inductor can be interconnected in an external circuit environment.

The inner core piece itself can be produced by pressing or by pressing and rounding off or by pressing and grinding.

The SMD inductor and the method for producing an SMD inductor are explained in greater detail by means of the schematic figures and exemplary embodiments shown, which do not restrict the subjects of the present applications.

In the figures:

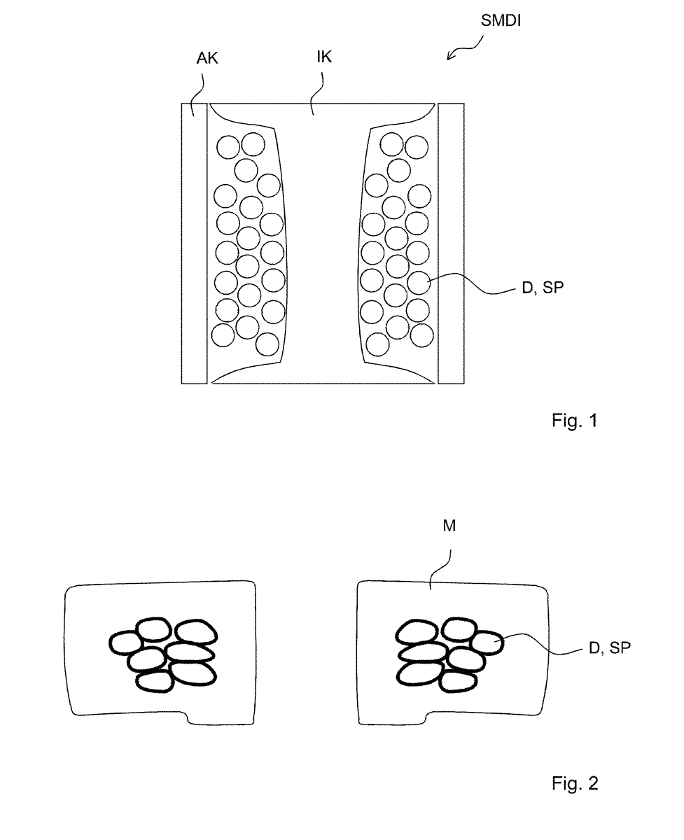

FIG. 1: shows a section through a sagittal plane of an SMD inductor SMDI shown schematically,

FIG. 2: shows a comparison with a customary component having a crimped winding,

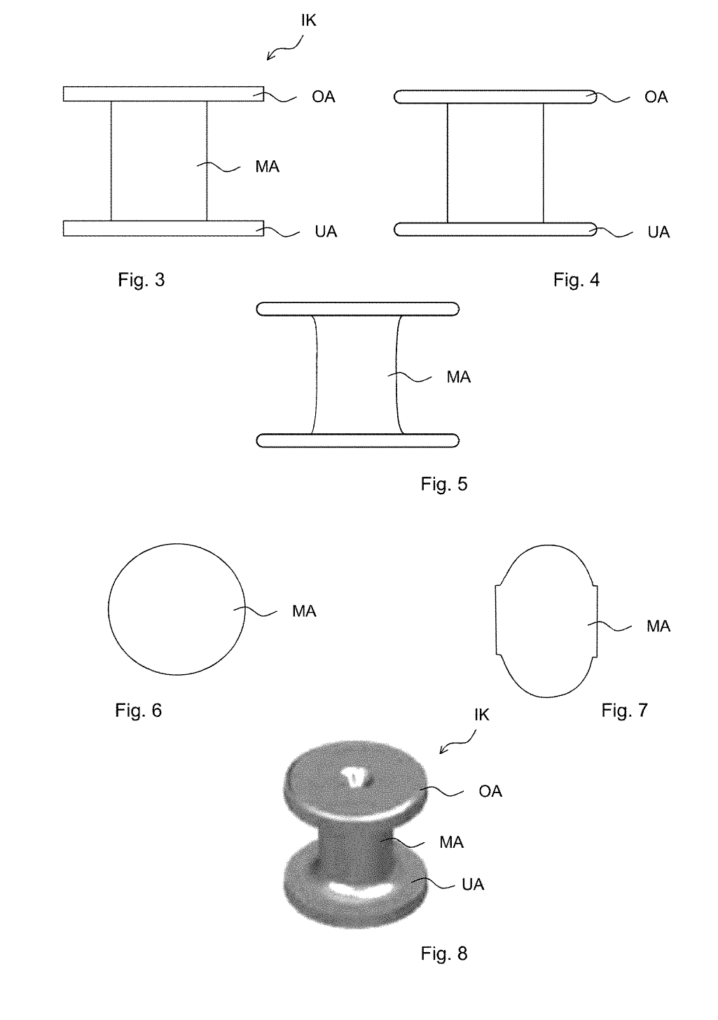

FIG. 3: shows a section through a sagittal plane of a possible inner core piece,

FIG. 4: shows a section through a sagittal plane of an innovative inner core piece,

FIG. 5: shows a section through a sagittal plane of a further possible inner core piece,

FIG. 6: shows a section through a transverse plane of a possible inner core piece,

FIG. 7: shows a section through a transverse plane of an alternative inner core piece,

FIG. 8: shows a perspective view of a possible inner core piece,

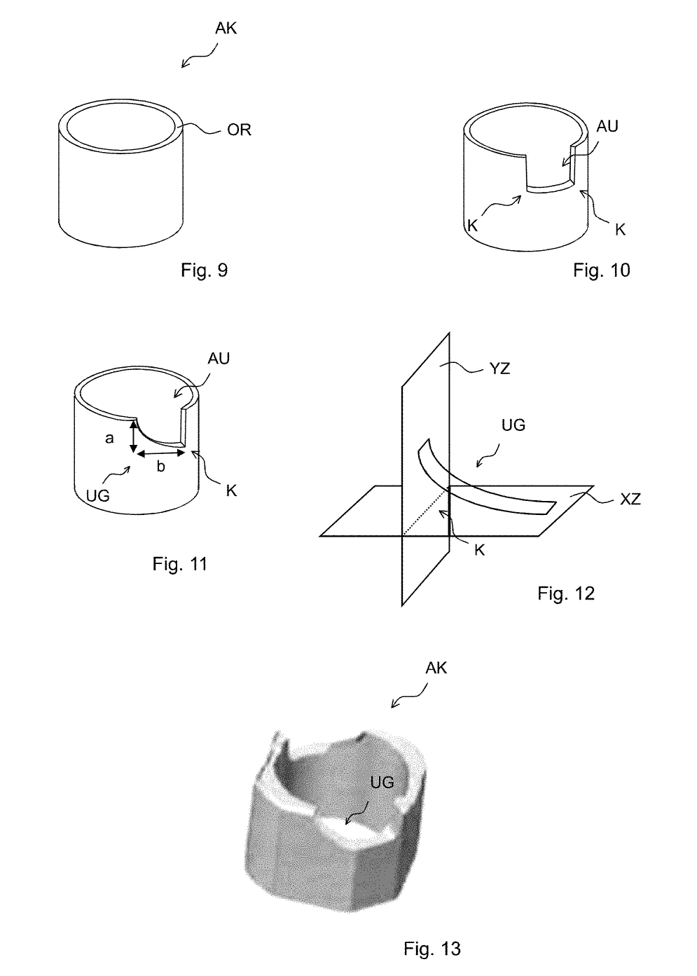

FIG. 9: shows a possible simple embodiment of an outer core piece with a sheath,

FIG. 10: shows a perspective view of an outer core piece with a cutout,

FIG. 11: shows a perspective illustration of a possible outer core piece in which an edge of the cutout is replaced by a rounded transition in order to reduce the risk of stress cracks,

FIG. 12: shows the perspective illustration of the arrangement of two planes and of the transition oriented with respect to the two,

FIG. 13: shows a perspective view of a possible outer core piece,

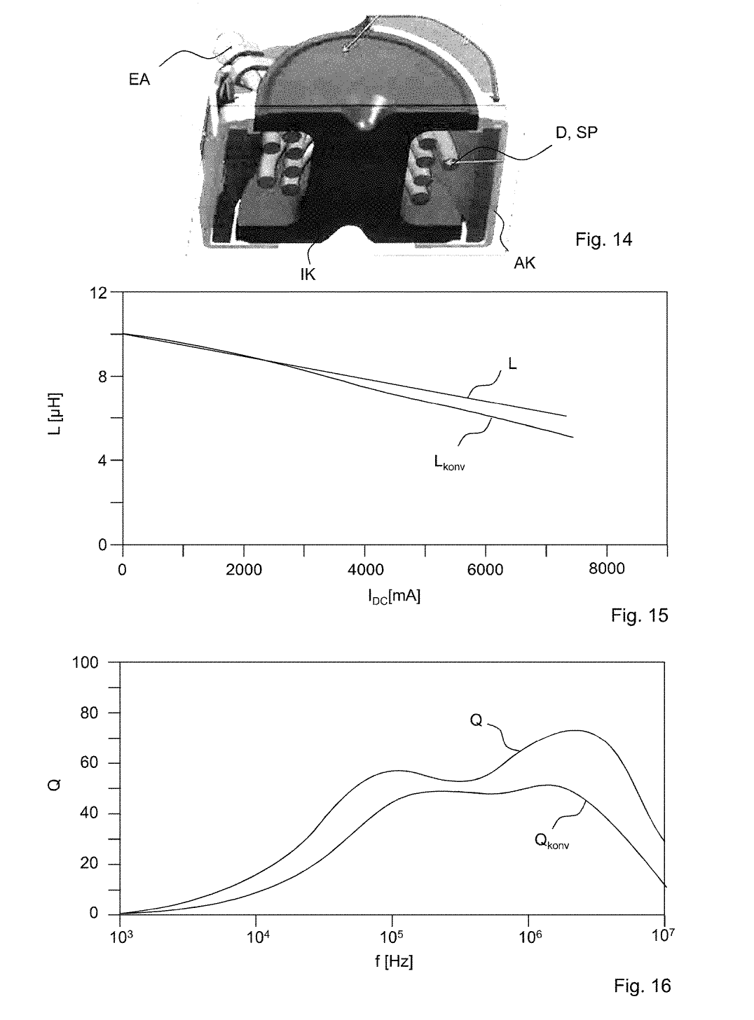

FIG. 14: shows a perspective view of a possible SMD inductor with a section through a sagittal plane,

FIG. 15: shows the dependence of the inductance value L on the current in comparison with the inductance L_{conv} of a customary SMD inductor,

FIG. 16: shows the frequency-dependent profile of the quality factor Q in comparison with the quality factor Q_{conv} of a customary SMD inductor.

FIG. 1 illustrates the basic construction of the SMD inductor SMDI. The inductor comprises an inner core piece IK, a wire D and an outer core piece AK. The wire D is wound around the inner core piece IK and forms the coil SP of the SMD inductor SMDI. The wire D can have a round or a rectangular cross section. The shape of the cross section of the wire remains practically unchanged during winding around the inner core IK. The risk of short circuits within the coil SP is significantly reduced.

In comparison therewith, FIG. 2 shows the arrangement of the wire D wound to form a coil SP in a customary SMD inductor. In this case, the wire together with a matrix material M is crimped to a desired shape, wherein the shape of the cross section of the wire changes. As a result of the crimping, in particular, there is the risk of short circuits within the coil SP, as a result of which the reliability of the inductor is significantly reduced.

FIG. 3 shows a possible shape of the inner core IK. The inner core IK has a central section MA, which can have the shape of a cylinder or the shape of which is similar to that of a cylinder. The inner core piece furthermore has a lower section UA and an upper section OA, between which the central section MA is arranged. As a result, the inner core piece IK acquires a shape onto which the wire for the coil can be wound in a simple manner.

FIG. 4 shows an alternative embodiment in which the lower section and the upper section have rounded edges.

FIG. 5 shows a further possible embodiment of the inner core piece in which, in addition to the lower and upper sections, the central section also has rounded edges in the course of the transition to the outer sections.

FIG. 6 shows a possible cross section through a transverse plane in the form of a circle. If the diameter of the circle is constant over the entire length of the central section MA, then the central section MA is a cylinder.

FIG. 7 shows an alternative embodiment in which the cross section through a transverse plane substantially constitutes an oval having side edges that are straight in sections.

FIG. 8 shows a perspective view of a possible inner core piece, wherein a rotationally symmetrical cutout is present in the upper section OA and (not visible in the perspective view) in the lower section UA.

FIG. 9 shows a simple embodiment of an outer core piece as a hollow cylinder having an upper margin OR.

FIG. 10 shows a possible shape of the outer core piece in which a cutout AU is provided in the lateral surface of the hollow cylinder, via which the coil of the inductor is interconnectable with an external circuit environment. In this case, the cutout AU comprises two edges at the upper margin OR and two further edges K, each of which is defined by the straight line of intersection of two mutually perpendicular planes. The edges K shown in FIG. 10 hold the greatest potential for stress cracks for the case where the inductor is subjected to external forces.

FIG. 11 shows an embodiment of the outer core for avoiding stress cracks, wherein at least one of the two lower edges is blunted by a transition UG. The transition UG constitutes an edgeless connection of the two perpendicular planes. Such a transition is described by two transition parameters a, b. The transition parameter a describes the portion bridged by the transition in the vertical direction. The parameter b describes the portion bridged by the transition in the horizontal direction. If the values for a and b are not identical, the transition is asymmetrical, which leads to a further improvement in the mechanical reliability of the inductor.

Analogously to the replacement of one edge K by the transition UG, one or a plurality of the other edges K can also be replaced by such a continuous transition.

FIG. 12 illustrates the spatial relationships between the two planes to be connected by the transition and the transition UG. An edge K present without a transition is replaced by the continuous transition UG at the location at which the areas YZ and XZ are intended to meet.

FIG. 13 shows a perspective view of a possible outer core piece having two cutouts, wherein each cutout has a plurality of transitions.

FIG. 14 shows the perspective view of an inductor cut through a sagittal plane and having an inner core piece IK, around which a wire D is wound to form a coil SP. The inner core piece IK with the coil is embedded into an outer core piece AK. Via external terminals EA, which can be led through cutouts in the outer core piece AK, the coil is interconnectable with an external circuit environment.

FIG. 15 shows the profile of the current-dependent inductance L in comparison with the inductance L_{conv} of a conventional inductor.

FIG. 16 shows the frequency-dependent profile of the quality factor Q in comparison with the quality factor Q_{conv} of a conventional SMD inductor.

The SMD inductor or the method for producing an SMD inductor is not restricted by the embodiments described or shown. Inductors having additional elements, e.g. mounts or a matrix material surrounding the wound wire, likewise constitute exemplary embodiments.

### LIST OF REFERENCE SIGNS

a, b: Transition parameters
AK: Outer core piece
AU: Cutout
D: Wire
EA: External terminal
f: Frequency
IDC: Current intensity of a direct current
IK: Inner core piece
K: Edge
L, L_{conv}: Inductance value
M: Matrix material
MA: Central section
OA: Upper section
OR: Upper margin
Q, Q_{conv}: Quality factor
SMDI: SMD inductor
SP: Coil
UA: Lower section
UG: Transition
YZ, XZ: Areas to be connected by a transition

1. An SMD inductor having a high peak current-carrying capacity and low losses, comprising
an inner core piece, an outer core piece and a coil having a wire, wherein
the inner core piece comprises an alloy,
the outer core piece comprises ferrite,
the wire is wound around the inner core piece,
the inner core piece with the wire is arranged in the outer core piece.

2. The SMD inductor according to claim 1, wherein
the inner core piece comprises a central section having a round, oval or polygonal cross section, and
the wire is wound around the central section.

3. The SMD inductor according to claim 1,
wherein the alloy comprises iron.

4. The SMD inductor according to claim 1,
wherein the alloy of the inner core piece is sintered.

5. The SMD inductor according to claim 4, wherein the inner core piece comprises individual, isolated grains.

6. The SMD inductor according to claim 1,
wherein the wire of the coil comprises 1.5≤Z≤100 turns.

7. The SMD inductor according to claim 1
furthermore comprising one or a plurality of wires, wherein the wires are connected in parallel or in series.

8. The SMD inductor according to claim 1,
wherein the inner core piece comprises a central section and all wires are wound around the central section.

9. The SMD inductor according to claim 1,
wherein
the outer core piece comprises an outer wall having a cutout,
the cutout comprises a first area and a second area, which is not parallel to the first area,
the transition from the first area to the second area for the purpose of avoiding stress cracks is shaped asymmetrically in relation to an angle bisector with respect to both areas.

10. The SMD inductor according to claim 9, wherein the transition comprises different transition dimensions a≠b.

11. The SMD inductor according to claim 1,
wherein
the peak current-carrying capacity is determined by the energy content L*I²,
L=0.9*L₀,
L₀ is the inductance without current,
I is the current at which L=0.9*L₀, and
L*I² is greater than or equal to 1.2 mWs in the case of a structural size having a basic area of 12 mm×12 mm,
L*I₂ is greater than or equal to 0.45 mWs in the case of a structural size having a basic area of 10 mm×10 mm,
L*I² is greater than or equal to 0.36 mWs in the case of a structural size having a basic area of 7 mm×7 mm, or
L*I² is greater than or equal to 0.25 mWs in the case of a structural size having a basic area of 6 mm×6 mm.

12. The SMD inductor according to claim 1,
wherein the losses at a frequency of 300 kHz, at 30 mT and at 20° C. are less than or equal to 600 kW/m³ in the core material.

13. A method for producing an SMD inductor, comprising the following steps of:
providing an inner core piece composed of an alloy, an outer core piece composed of ferrite, and a wire,
winding the wire onto the inner core piece to form a coil,
arranging the inner core piece with the coil in the outer core piece,
interconnecting the coil with external terminals.
